(19) United States
(12) Patent Application Publication
(10) Pub. No.: US 2011/0082592 A1
(43) Pub. Date: Apr. 7, 2011

(54) AIR-CONDITIONING CONTROL SYSTEM AND AIR-CONDITIONING CONTROL METHOD

(75) Inventors: Seiichi SAITO, Kawasaki (JP); Junichi ISHIMINE, Kawasaki (JP); Ikuro NAGAMATSU, Kawasaki (JP); Masahiro SUZUKI, Kawasaki (JP); Tadashi KATSUI, Kawasaki (JP); Yuji OHBA, Kawasaki (JP); Nobuyoshi YAMAOKA, Kawasaki (JP); Akira UEDA, Kawasaki (JP); Yasushi URAKI, Kawasaki (JP)

(73) Assignee: FUJITSU LIMITED, Kawasaki-shi (JP)

(21) Appl. No.: 12/897,014

(22) Filed: Oct. 4, 2010

(30) Foreign Application Priority Data
Oct. 5, 2009 (JP) 2009-231858

(51) Int. Cl. G05B 19/00; F24F 11/00

(52) U.S. Cl. 700/276; 454/239

(57) ABSTRACT

Air that is cooled with ground temperature is circulated in a room, by delivering air in the room outward to an exhaust pipe with a predetermined exhaust pressure; sucking the air discharged from the exhaust pipe with a predetermined suction pressure via an underground path that is formed in ground by the air discharged from the exhaust pipe into the ground; and delivering the sucked air into the room.

### CROSS-REFERENCE TO RELATED APPLICATION

This application is based upon and claims the benefit of priority of the prior Japanese Patent Application No. 2009-231858, filed on Oct. 5, 2009, the entire contents of which are incorporated herein by reference.

### FIELD

The embodiments discussed herein are directed to an air-conditioning control system and an air-conditioning control method.

### BACKGROUND

In a data center or other facilities that accommodates electronics equipment, such as a server and communication equipment, it is desirable to keep the inside of a room at a certain temperature or lower, to avoid malfunction of various kinds of electronics equipment arranged inside the room. Therefore, a data center or other facilities is assumed to keep the inside of a room at a certain temperature or lower by usually using an air conditioner provided indoors or outdoors; and when cooling the inside of the room by the air conditioner, power and energy for operating the air conditioner is needed additionally to power needed for operations of electronics equipment; consequently, an emission of carbon dioxide (CO₂) caused by the additional power results in an environmental problem.

For this reason, a technology of improving cooling efficiency is proposed to reduce emission of carbon dioxide (CO₂) in a data center or other facilities. Specifically, proposed are a technology of equalizing indoor temperature by evenly distributing processing loads on electronics equipment as much as possibly, and a technology of controlling temperature and/or air-flow rate of an air conditioner in accordance with a heat release from electronics equipment. When using such technologies, the operational efficiency of an air conditioner is improved, so that reduction in extra power can be expected.

Moreover, an air-conditioning control system that uses ground temperature when cooling or heating a room is known. For example, a technology of cooling the inside of a room by embedding a pipe under the ground, and using a liquid or a gas in the pipe that is cooled under the ground. Furthermore, proposed is a technology of increasing the temperature of a room by increasing the temperature in the ground by discharging air in the room into the ground with an injection pipe, and circulating air in the ground into the room. Such air-conditioning control system using ground temperature is often used mainly by a private house, or a public facility.
Patent Document 1: Japanese Laid-open Patent Publication No. 63-189743
Patent Document 2: Japanese Laid-open Patent Publication No. 2000-97586
Patent Document 3: Japanese Laid-open Patent Publication No. 2003-247731
Patent Document 4: Japanese Laid-open Patent Publication No. 2004-301470
Patent Document 5: Japanese Laid-open Patent Publication No. 2005-009737

However, even using any of the above conventional technologies, there is a problem that the inside of a room in a data center or other facilities having a large heat release may not be efficiently cooled. Specifically, the conventional technology of evenly distributing processing loads on electronics equipment, and the conventional technology of controlling an air conditioner in accordance with a heat release from electronics equipment, only increase the efficiency of an air conditioner, and a reduction in extra power is limited. Consequently, to cool a data center or other facilities that includes a number of electronics devices arranged indoors in operation, and has a high intensity of heat release, extra power for operating an air conditioner is large, and an extra emission of carbon dioxide (CO₂) is large.

In a case of an air-conditioning control system using ground temperature, because a liquid or a gas in a pipe embedded in the ground is cooled by heat exchange with a ground layer via the surface of the pipe, the cooling efficiency depends on the surface area of the pipe. Therefore, it is conceivable to enlarge the surface area of a pipe to be embedded; however, required time and effort and manpower to embed a thick pipe are massive, and enlargement of the surface area has a limitation. For this reason, although a conventional air-conditioning control system using ground temperature may be suitable for employing it to a private house, it is unsuitable for cooling the inside of a room having a large heat release, such as a data center.

A conventional technology of discharging indoor air into ground with an injection pipe is just a technology of simply storing hot air temporarily in the ground, and cannot be applied when cooling indoor temperature.

### SUMMARY

According to an aspect of an embodiment of the invention, an air-conditioning control system includes an exhaust pipe that discharges air into ground; an outward delivery unit that delivers air in a room outward to the exhaust pipe at a predetermined exhaust pressure; a suction pipe that sucks air discharged by the exhaust pipe via an underground path that is formed in ground by air discharged by the exhaust pipe; and an inward delivery unit that delivers air sucked from the suction pipe at a predetermined suction pressure into the room.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram that depicts a configuration example of an air-conditioning control system according to a first embodiment of the present invention;

FIG. 2 is a schematic diagram that depicts a configuration example of an air-conditioning control system according to a second embodiment of the present invention;

FIG. 3 is a schematic diagram for explaining an outline of exhaust pressure control by a control unit according to the second embodiment;

FIG. 4 is a schematic diagram for explaining an example of suction pressure control by the control unit according to the second embodiment;

FIG. 5 is a schematic diagram for explaining an example of the exhaust pressure control by the control unit in a high-pressure mode;

FIG. 6 is a schematic diagram for explaining an example of the exhaust pressure control by the control unit in the high-pressure mode;

FIG. 7 is a schematic diagram for explaining an example of the exhaust pressure control by the control unit in the high-pressure mode;

FIG. 8 is a schematic diagram for explaining an example of the exhaust pressure control by the control unit in the high-pressure mode;

FIG. 9 is a schematic diagram for explaining an example of the exhaust pressure control by the control unit in a low-pressure mode;

FIG. 10 is a flowchart that depicts the exhaust pressure control by the control unit in the high-pressure mode;

FIG. 11 is a flowchart that depicts the exhaust pressure control by the control unit in the low-pressure mode;

FIG. 12 is a schematic diagram for explaining a concrete example of a second pressure;

FIG. 13 is a schematic diagram that depicts relation between distance and temperature between pipes;

FIG. 14 is a schematic diagram that depicts an example of embedding positions of exhaust pipes and suction pipes;

FIG. 15 is a schematic diagram that depicts an example of embedding positions of the exhaust pipes and the suction pipes;

FIG. 16 is a schematic diagram that depicts an example of embedding positions of the exhaust pipes and the suction pipes;

FIG. 17 is a schematic diagram that depicts a configuration example of a compressor pump;

FIG. 18 is a flowchart that depicts control by a control unit according to a fourth embodiment of the present invention;

FIG. 19 is a schematic diagram for explaining the control by the control unit according to the fourth embodiment; and

FIG. 20 is a schematic diagram that depicts a computer that executes an air-conditioning control program.

### DESCRIPTION OF EMBODIMENTS

Preferred embodiments of the present invention will be explained with reference to accompanying drawings. However, the air-conditioning control system, the air-conditioning control method, and the air-conditioning control program disclosed in the present application of the present invention are not limited to the embodiments.

### [a] First Embodiment

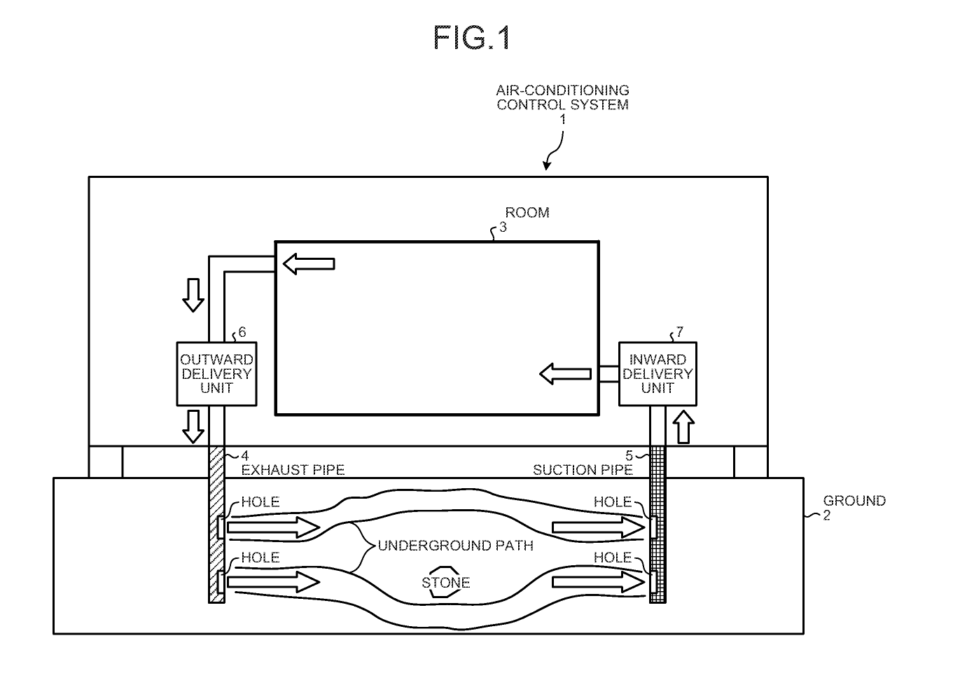

First of all, a configuration of an air-conditioning control system according to a first embodiment of the present invention is explained below with reference to FIG. 1. FIG. 1 is a schematic diagram that depicts a configuration example of the air-conditioning control system according to the first embodiment. An “arrow” depicted in FIG. 1 illustrates an example of an air flow.

As depicted in FIG. 1, an air-conditioning control system 1 includes an exhaust pipe 4 and a suction pipe 5 both of which are embedded in ground 2, and an outward delivery unit 6 and an inward delivery unit 7 both of which are connected to a room 3.

The exhaust pipe 4 discharges air into the ground 2. According to the example depicted in FIG. 1, the exhaust pipe 4 includes holes, and discharges air via the holes into the ground 2. The suction pipe 5 sucks air discharged by the exhaust pipe 4, via a path that is formed under the ground by the air discharged by the exhaust pipe 4 (hereinafter, “underground path”). According to the example depicted in FIG. 1, the suction pipe 5 includes holes, and sucks air via the holes from the ground 2.

The outward delivery unit 6 delivers indoor air in the room 3 outward to the exhaust pipe 4 at a predetermined pressure (hereinafter, “exhaust pressure”). The inward delivery unit 7 sucks air from the suction pipe 5 at a predetermined pressure (hereinafter, “suction pressure”), and delivers the sucked air into the room 3. Each of the outward delivery unit 6 and the inward delivery unit 7 includes a function of varying the exhaust pressure and the suction pressure, which are set to an exhaust pressure and a suction pressure optimal to obtain a desired air-flow rate needed for indoor air conditioning in accordance with a forming condition of an underground path. General soil includes lumps of soil with small void content, small stones, and the like, so that soil of various properties is mixed. By appropriately controlling the exhaust pressure, an air path is formed in soil with small void content, a small stone is moved, and an air path is formed around a stone, so that an underground path circulating from the exhaust pipe 4 to the suction pipe 5 is formed.

As described above, the air-conditioning control system 1 according to the first embodiment discharges indoor air from the exhaust pipe 4, and returns the air discharged from the exhaust pipe 4 indoors by sucking it from the suction pipe 5 via the underground path that is at least partially formed by the discharged air. Accordingly, the air-conditioning control system 1 according to the first embodiment can efficiently cools indoor air at ground temperature.

Specifically, a conventional technology of cooling indoor air through a pipe embedded in the ground has a low cooling efficiency because heat exchange is performed on the surface of the pipe, as described above. On the other hand, the air-conditioning control system 1 according to the first embodiment delivers outward indoor air into the ground 2, thereby being capable to cool air that is diffused in the ground 2, at ground temperature. In other words, the cooling efficiency of the air-conditioning control system 1 according to the first embodiment does not depend on the surface area of a pipe, while the above-described conventional technology does, thereby being capable to cool indoor air efficiently.

Moreover, the air-conditioning control system 1 according to the first embodiment circulates indoor air through the room 3, the exhaust pipe 4, the underground path formed in the ground 2, and the suction pipe 5 in order. In other words, the air-conditioning control system 1 according to the first embodiment circulates the discharged air instead of discarding the indoor air in the room 3 to the ground 2. For this reason, the air-conditioning control system 1 according to the first embodiment can be favorable for environment because hot air is reused, compared with, for example, a conventional technology of just emitting air into the ground and outdoors.

### [b] Second Embodiment

The air-conditioning control system explained in the first embodiment is explained below by using a concrete example. A second embodiment of the present invention explains below an example where the air-conditioning control system explained in the first embodiment is applied to a data center. Moreover, the second embodiment explains below processing of forming an underground path.

Configuration of Air-Conditioning Control System According to Second Embodiment

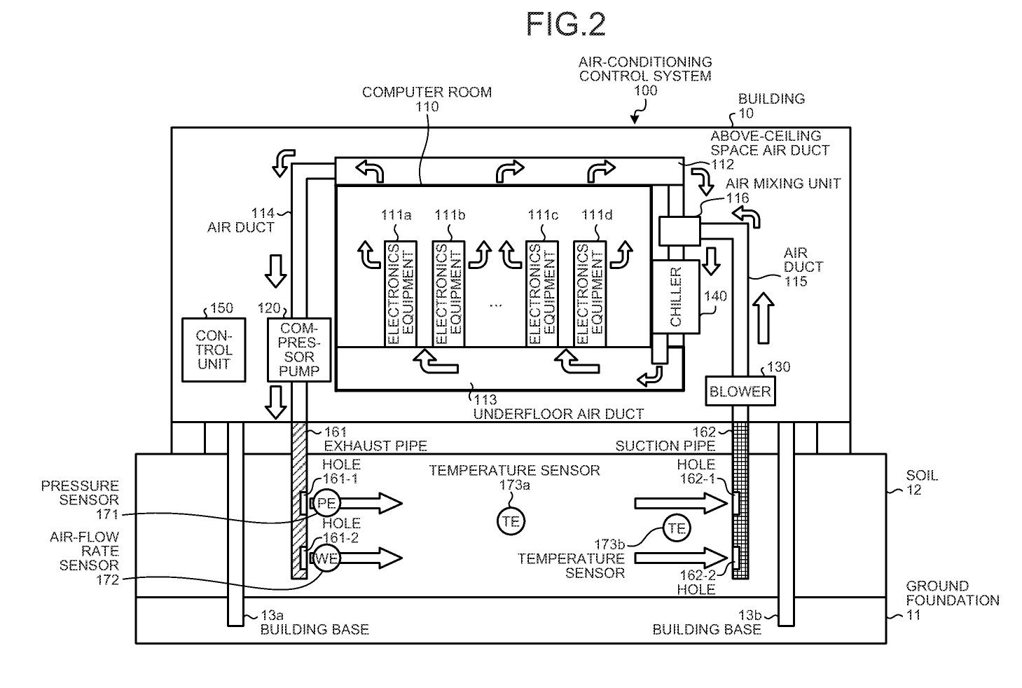

First of all, a configuration of an air-conditioning control system according to the second embodiment is explained below. FIG. 2 is a schematic diagram that depicts a configuration example of an air-conditioning control system 100 according to the second embodiment. An “arrow” depicted in FIG. 2 illustrates an example of an air flow.

The air-conditioning control system 100 depicted in FIG. 2 is applied to a building 10 built on a soil 12. The soil 12 includes stones, gravel, and sand, and is formed on a ground foundation 11. According to the example depicted in FIG. 2, the building 10 is anchored on the soil 12 as building bases 13a and 13b are embedded into the ground foundation 11 and the soil 12.

It is assumed that the building 10 depicted in FIG. 2 is a data center. The building 10 includes a computer room 110, As depicted in FIG. 2. Moreover, in addition to the computer room 110, the building 10 includes a compressor pump 120, a blower 130, a chiller 140, a control unit 150, an exhaust pipe 161, and a suction pipe 162. Furthermore, a pressure sensor 171, an air-flow rate sensor 172, and temperature sensors 173a and 173b are embedded in the soil 12.

The computer room 110 is provided with electronics equipment 111a to 111d. The electronics equipment 111a to 111d is, for example, a server, a storage device, a communication device, such as a router and a switching hub, and an uninterruptible power supply (UPS). The electronics equipment 111a to 111d generates heat when operating, so that a room temperature is raised.

Moreover, as depicted in FIG. 2, the computer room 110 includes an above-ceiling space air duct 112 in an above-ceiling space. The above-ceiling space air duct 112 is a duct through which air can circulate. The above-ceiling space air duct 112 is connected to the compressor pump 120 via an air duct 114. The air duct 114 is a path that enables air to move between the above-ceiling space air duct 112 and the compressor pump 120. Moreover, the above-ceiling space air duct 112 is connected to the chiller 140 via an air mixing unit 116.

Furthermore, as depicted in FIG. 2, the computer room 110 includes an underfloor air duct 113 under its floor. The underfloor air duct 113 is a path through which air can move. The underfloor air duct 113 is connected to the chiller 140, and air is discharged from the chiller 140.

The compressor pump 120 delivers indoor air in the computer room 110 outward to the exhaust pipe 161 at a predetermined exhaust pressure. Specifically, the compressor pump 120 delivers air sent from the computer room 110 via the above-ceiling space air duct 112 and the air duct 114, outward to the exhaust pipe 161 at a predetermined exhaust pressure. The value of the “exhaust pressure” is controlled by the control unit 150, which will be described later. The compressor pump 120 and the control unit 150 correspond to the outward delivery unit 6 depicted in FIG. 1.

The blower 130 sucks air from the suction pipe 162 at a predetermined suction pressure, and delivers the sucked air into the computer room 110. Specifically, the blower 130 delivers the air sucked from the suction pipe 162 into the computer room 110 via an air duct 115, the air mixing unit 116, the chiller 140, and the underfloor air duct 113. The value of the “suction pressure” is controlled by the control unit 150. The blower 130 and the control unit 150 correspond to the inward delivery unit 7 depicted in FIG. 1.

The chiller 140 cools air sucked from the air mixing unit 116, and sends the cooled air into the underfloor air duct 113. For example, the chiller 140 sucks air in the computer room 110 via the above-ceiling space air duct 112 and the air mixing unit 116, cools the sucked air, and then sends it into the underfloor air duct 113. Moreover, for example, the chiller 140 cools air sucked from by the blower 130 from the suction pipe 162, and then sends it into the underfloor air duct 113.

The exhaust pipe 161 discharges air to the soil 12. Specifically, the exhaust pipe 161 includes holes 161-1 and 161-2, and discharges air via the holes 161-1 and 161-2 to the soil 12. The suction pipe 162 sucks air from the soil 12. Specifically, the suction pipe 162 includes holes 162-1 and 162-2, and sucks air via the holes 162-1 and 162-2 from the soil 12. The exhaust pipe 161 and the suction pipe 162 described above are formed, for example, in shape to a column or a square pole that has a hollow part through which air can move freely.

It is preferable that at the closer position to the ground surface, the smaller the area of each of the holes 161-1 and 161-2 and the holes 162-1 and 162-2 is formed; while at the deeper position in the ground, the larger the area of each of them is formed. Accordingly, air can be discharged from each of the holes at a substantially equal air-flow rate. Moreover, the holes 162-1 and 162-2 of the suction pipe 162 can include a filter that removes stones, sand, water, unwanted liquid and gas, bacteria, a chemical substance, and the like.

The pressure sensor 171 detects pressure. According to the example depicted in FIG. 2, the pressure sensor 171 detects exhaust pressure of the exhaust pipe 161. The air-flow rate sensor 172 detects an air-flow rate. According to the example depicted in FIG. 2, the air-flow rate sensor 172 detects an exhaust air-flow rate of air discharged from the exhaust pipe 161 into the soil 12. Although the pressure sensor 171 and the air-flow rate sensor 172 in the example depicted in FIG. 2 are placed in the soil 12, they can be placed in the holes 161-1 and 161-2 of the exhaust pipe 161. The temperature sensors 173a and 173b detect a temperature inside the soil 12.

The control unit 150 controls the air-conditioning control system 100 according to the second embodiment. The control unit 150 according to the second embodiment is connected to the compressor pump 120, the blower 130, the chiller 140, the pressure sensor 171, the air-flow rate sensor 172, and the temperature sensors 173a and 173b, in a wired manner or a wireless manner, although it is not depicted in FIG. 2. The control unit 150 controls exhaust pressure of the compressor pump 120 and suction pressure of the blower 130, based on the exhaust pressure detected by the pressure sensor 171 and the exhaust air-flow rate detected by the air-flow rate sensor 172.

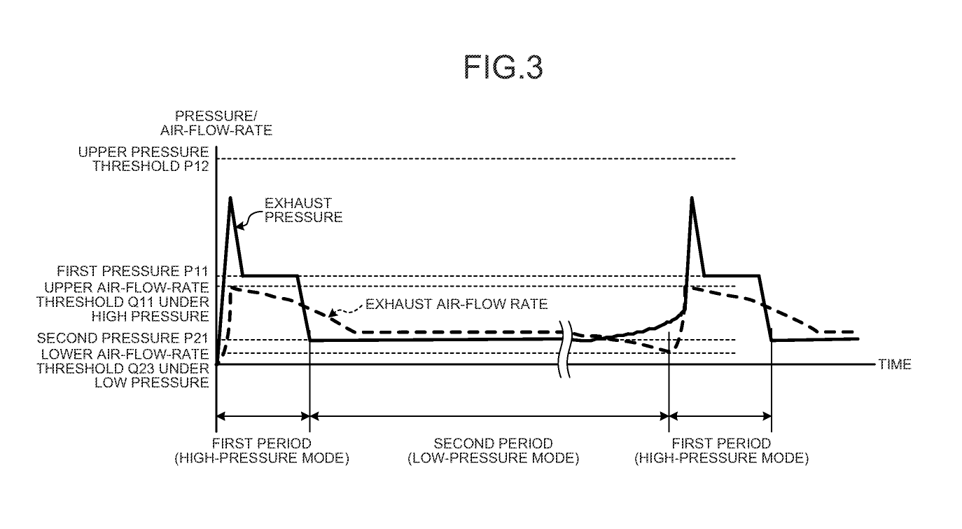

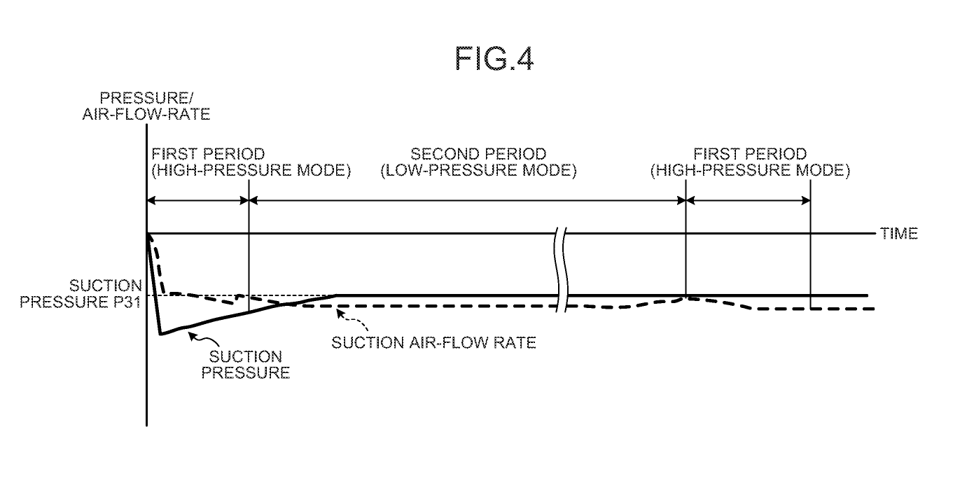

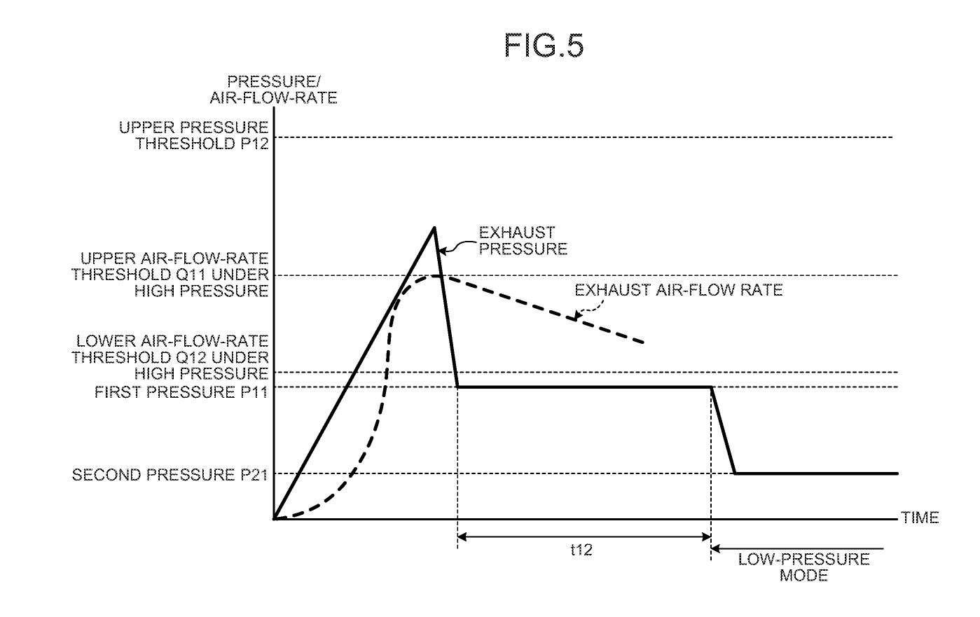

Exhaust pressure control and suction pressure control by the control unit 150 are explained below. An outline of the exhaust pressure control and the suction pressure control by the control unit 150 is explained below at first with reference to FIGS. 3 and 4; and then the exhaust pressure control by the control unit 150 is explained below in detail with reference to FIGS. 5 to 9. FIG. 3 is a schematic diagram for explaining an outline of the exhaust pressure control by the control unit 150 according to the second embodiment. The vertical axis depicted in FIG. 3 denotes pressure or air-flow rate, and the horizontal denotes time. A solid line in FIG. 3 indicates the exhaust pressure of the exhaust pipe 161, and a broken line indicates the exhaust air-flow rate of the exhaust pipe 161. According to an example depicted in FIG. 3, it is assumed that the time “0” denotes a time point at which the air-conditioning control system 100 according to the second embodiment is initially activated after the installation.

According to the example depicted in FIG. 3, when initially activating, in order to form an underground path, the control unit 150 increases the exhaust pressure of the compressor pump 120 until the exhaust air-flow rate reaches an upper air-flow-rate threshold Q11 under high pressure. When the exhaust air-flow rate then reaches the upper air-flow-rate threshold Q11 under high pressure, the control unit 150 then sets and controls the exhaust pressure of the compressor pump 120 to a first pressure P11. The control unit 150 then fixes the exhaust pressure of the compressor pump 120 at the first pressure P11 until a predetermined time has elapsed. Accordingly, the control unit 150 can form an underground path in the ground 2. Hereinafter, a period during which an underground path is formed is sometimes called a “first period”. An operation mode in which the exhaust pressure of the compressor pump 120 is set and controlled to a high pressure is sometimes called a “high-pressure mode”. In other words, the control unit 150 operates the compressor pump 120 in the high-pressure mode in the first period.

The reason why the exhaust pressure is increased until the exhaust air-flow rate reaches the upper air-flow-rate threshold Q11 under high pressure in the above example is, for example, for removing a stone that cannot be removed at the first pressure P11, forming an underground path around a large stone by making a route around the stone, and forming voids in a lump of soil with a small void content or a high viscosity. Moreover, the reason why the exhaust pressure is set and controlled to the first pressure P11 when the exhaust air-flow rate reaches the upper air-flow-rate threshold Q11 under high pressure in the above example is because, if the exhaust pressure of the compressor pump 120 is excessively increased, there is a possibility that air inside the compressor pump 120 may rise upward. Therefore, according to the above example, when the exhaust air-flow rate reaches the upper air-flow-rate threshold under high pressure, the control unit 150 determines that a stone that cannot be removed at the first pressure P11 is removed, or that an underground path is formed around a large stone or in soil with small void content, and then sets and controls the exhaust pressure to the first pressure P11.

Subsequently, in the example depicted in FIG. 3, after a predetermined time has elapsed, the control unit 150 sets and controls the exhaust pressure of the compressor pump 120 to a second pressure P21 that is a low pressure. Accordingly, the compressor pump 120 delivers indoor air in the computer room 110 outward to the exhaust pipe 161 at the second pressure P21. The air delivered to the exhaust pipe 161 is discharged from the exhaust pipe 161 to the underground path formed in the soil 12, and cooled at ground temperature. The air cooled at ground temperature is sucked by the blower 130 via the suction pipe 162, and delivered to the computer room 110. Hereinafter, a period during which air in the computer room 110 is circulated via the underground path at a low exhaust pressure is sometimes called a “second period”. An operation mode in which the exhaust pressure of the compressor pump 120 is set and controlled to a low pressure is sometimes called a “low-pressure mode”. In other words, the control unit 150 operates the compressor pump 120 in the low-pressure mode in the second period.

The reason why the exhaust pressure is set and controlled to the second pressure P21 in the second period in the above example is because, for example, when an underground path has been formed, even if air is discharged into the soil 12 at a low pressure, the air moves through the underground path and reaches the suction pipe 162. In other words, when an underground path has been formed, even if the exhaust pressure is low, indoor air in the computer room 110 can be circulated via the soil 12. In this way, the control unit 150 circulates indoor air in the computer room 110 in the second period at the second pressure P21 that is a low pressure, thereby being capable to avoid rise in the temperature of air caused by the compressor pump 120, as a result, the indoor air can be efficiently cooled. Moreover, the control unit 150 controls the exhaust pressure of the compressor pump 120 to a low pressure in the second period, thereby being capable to reduce power consumption.

After that, when the exhaust air-flow rate becomes equal to or lower in the second period than a predetermined lower air-flow-rate threshold Q23 under low pressure, the control unit 150 operates the compressor pump 120 in the high-pressure mode again. Specifically, the control unit 150 increases the exhaust pressure of the compressor pump 120 until the exhaust air-flow rate reaches the upper air-flow-rate threshold Q11 under high pressure, and sets and controls the exhaust pressure of the compressor pump 120 to the first pressure P11 when the exhaust air-flow rate reaches the upper air-flow-rate threshold Q11 under high pressure. After a predetermined time has elapsed since the control unit 150 sets and controls the exhaust pressure of the compressor pump 120 to the first pressure P11, the control unit 150 operates the compressor pump 120 in the low-pressure mode.

The reason why the compressor pump 120 is operated in the high-pressure mode when the exhaust air-flow rate becomes equal to or lower than the predetermined lower air-flow-rate threshold Q23 under low pressure, because there is a possibility that the underground path may be blocked. Because an underground path is formed in the soil 12, it is sometimes blocked with a stone, gravel, or sand with time. Therefore, when the exhaust air-flow rate decreases, the control unit 150 operates the compressor pump 120 in the high-pressure mode again, thereby being capable to form an underground path again.

The exhaust pressure control by the control unit 150 according to the second embodiment is explained below with reference to FIG. 4. FIG. 4 is a schematic diagram for explaining an example of the suction pressure control by the control unit 150 according to the second embodiment. The vertical axis and the horizontal axis depicted in FIG. 4 are similar to the example depicted in FIG. 3. Moreover, a solid line in FIG. 4 indicates the suction pressure, and a broken line indicates the suction air-flow rate that is an air-flow rate of air sucked by the suction pipe 162. The suction pressure and the suction air-flow rate are expressed by negative value in FIG. 4. In other words, the lower in FIG. 4, the suction pressure and the suction air-flow rate are the higher.

According to the example depicted in FIG. 4, the control unit 150 fixes the suction pressure of the blower 130 to a suction pressure P31, regardless whether the first period or the second period. However, control of the suction pressure by the control unit 150 is not limited to the example depicted in FIG. 4. For example, the control unit 150 can set and control the suction pressure to a high pressure in the first period. Accordingly, the control unit 150 can easily form an underground path in the first period. Moreover, for example, the control unit 150 can set and control the suction pressure to a low pressure in the second period. Accordingly, the control unit 150 can avoid rise in the temperature of air caused by the blower 130 in the second period, and can reduce power consumption.

In this way, the control unit 150 controls the exhaust pressure of the compressor pump 120 and the suction pressure of the blower 130, thereby being capable to form an underground path in the first period, and to circulate indoor air in the computer room 110 efficiently in the second period. Furthermore, the control unit 150 can form an underground path again even when there is a possibility that the formed underground path may be blocked.

The exhaust pressure control by the control unit 150 in the high-pressure mode is explained below in detail with reference to FIGS. 5 to 8. FIGS. 5 to 8 are schematic diagrams for explaining examples of the exhaust pressure control by the control unit 150 in the high-pressure mode.

According to an example depicted in FIG. 5, the control unit 150 increases at first the exhaust pressure of the compressor pump 120 until the exhaust air-flow rate of the exhaust pipe 161 reaches the upper air-flow-rate threshold Q11 under high pressure. According to the example depicted in FIG. 5, because the exhaust air-flow rate of the exhaust pipe 161 reaches the upper air-flow-rate threshold Q11 under high pressure, the control unit 150 sets and controls the exhaust pressure of the compressor pump 120 to the first pressure P11. After a predetermined time t12 has elapsed since the control unit 150 sets the exhaust pressure to the first pressure P11, the control unit 150 then sets and controls the exhaust pressure of the compressor pump 120 to the second pressure P21, which is the initial value of the low-pressure mode (the second period), and shifts the operation to the low-pressure mode. A standard default value is used as the value of the second pressure P21 at that moment. The reason why the time t12 is provided is in order to determine whether an underground path is sufficiently formed. If an air-flow rate equal to or higher than a lower air-flow-rate threshold Q12 under high pressure is maintained during the time t12 even after the pressure has been reduced to the first pressure P11, it is determined that the formed underground path is sufficient. The example depicted in FIG. 5 is similar to the example depicted in FIG. 3.

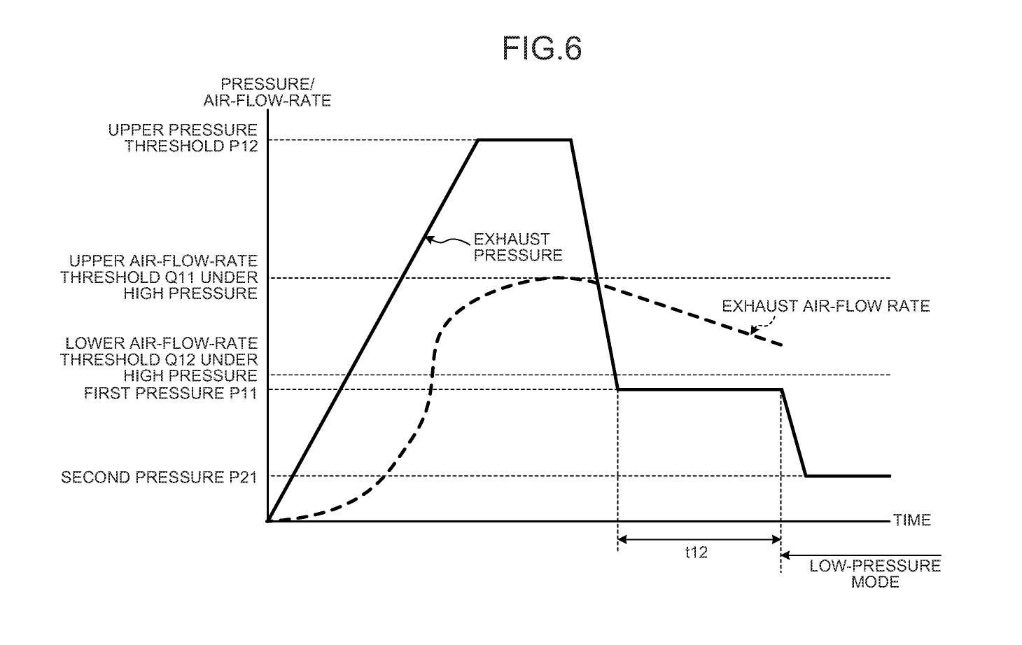

According to an example depicted in FIG. 6, similarly to the example depicted in FIG. 5, the control unit 150 increases at first the exhaust pressure of the compressor pump 120 until the exhaust air-flow rate reaches the upper air-flow-rate threshold Q11 under high pressure. In the case of the example depicted in FIG. 6, because the exhaust pressure of the exhaust pipe 161 reaches a predetermined upper pressure threshold P12 before the exhaust air-flow rate reaches the upper air-flow-rate threshold Q11 under high pressure, the control unit 150 stops increasing the exhaust pressure of the compressor pump 120. The control unit 150 then fixes the exhaust pressure of the compressor pump 120 at the upper pressure threshold P12, and sets and controls the exhaust pressure of the compressor pump 120 to the first pressure P11 when the exhaust air-flow rate reaches the upper air-flow-rate threshold Q11 under high pressure. Similarly to the example depicted in FIG. 5, after the predetermined time t12 has elapsed since the exhaust pressure is set to the first pressure P11, the control unit 150 sets and controls the exhaust pressure of the compressor pump 120 to the second pressure P21, which is the initial value of the low-pressure mode (the second period), and shifts the operation to the low-pressure mode. The standard default value is used as the value of the second pressure P21 at that moment, similarly to the case in FIG. 5. The reason why the time t12 is provided is similar to the explanation about FIG. 5.

According to the example depicted in FIG. 6, the reason why increasing of the exhaust pressure is stopped when the exhaust air-flow rate of the exhaust pipe 161 reaches the predetermined upper pressure threshold P12 is because there is a possibility that if the exhaust pressure is excessively increased, only a fixed underground path may be formed in the soil 12. Moreover, the reason for this is because if the exhaust pressure is excessively increased, there are a possibility that power consumption may increase, and a possibility that air may have a high temperature caused by the compressor pump 120, resulting in a decrease in cooling efficiency.

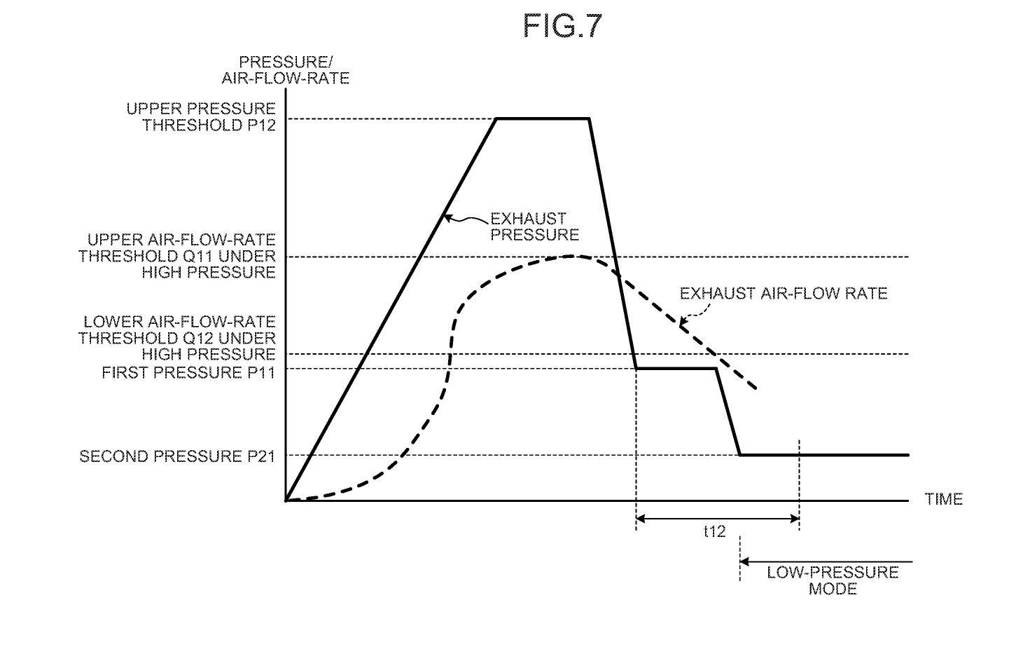

According to an example depicted in FIG. 7, the control unit 150 increases at first the exhaust pressure of the compressor pump 120 until the exhaust air-flow rate reaches the upper air-flow-rate threshold Q11 under high pressure. The exhaust pressure then reaches the predetermined upper pressure threshold P12 before the exhaust air-flow rate reaches the upper air-flow-rate threshold Q11 under high pressure, the control unit 150 stops increasing the exhaust pressure of the compressor pump 120, similarly to the example depicted in FIG. 6. The control unit 150 then fixes the exhaust pressure of the compressor pump 120 to the upper pressure threshold P12, and then sets and controls the exhaust pressure of the compressor pump 120 to the first pressure P11 when the exhaust air-flow rate reaches the upper air-flow-rate threshold Q11 under high pressure. In the case of the example depicted in FIG. 7, the exhaust air-flow rate becomes lower than the predetermined lower air-flow-rate threshold Q12 under high pressure before the predetermined time t12 has elapsed since the exhaust pressure is set to the first pressure P11. In such case, it is determined that an underground path is formed; however, resistance in the underground path is large. In such case, when the exhaust air-flow rate becomes lower than the lower air-flow-rate threshold Q12 under high pressure, the control unit 150 sets and controls the exhaust pressure of the compressor pump 120 to the second pressure P21, which is the initial value of the low-pressure mode (the second period), and shifts the operation to the low-pressure mode. However, the value of the second pressure P21 used in the case in FIG. 7 is a larger value than the standard default value in FIGS. 5 and 6. The reason for this is because it is determined that the resistance in the underground path in the case in FIG. 7 is larger than those in the cases in FIGS. 5 and 6. When the exhaust air-flow rate becomes lower than the predetermined lower air-flow-rate threshold Q12 under high pressure, the operation is shifted to the low-pressure mode in FIG. 7, because it can be determined that the resistance in underground path is large before a lapse of the time t12. However, it can be shifted to the low-pressure mode after a lapse of the time t12 even in the case of the example in FIG. 7.

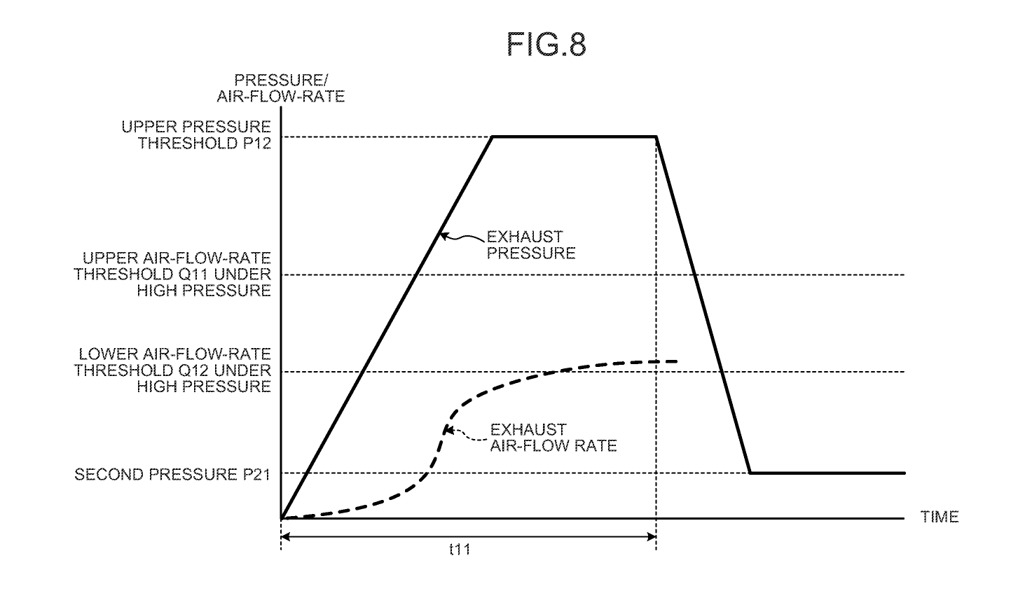

According to an example depicted in FIG. 8, the control unit 150 increases at first the exhaust pressure of the compressor pump 120 until the exhaust air-flow rate reaches the upper air-flow-rate threshold Q11 under high pressure. The exhaust pressure then reaches the predetermined upper pressure threshold P12 before the exhaust air-flow rate reaches the upper air-flow-rate threshold Q11 under high pressure, the control unit 150 stops increasing the exhaust pressure of the compressor pump 120, similarly to the example depicted in FIG. 6. The control unit 150 then fixes the exhaust pressure of the compressor pump 120 to the upper pressure threshold P12. In the case of the example depicted in FIG. 8, the exhaust air-flow rate does not reaches the upper air-flow-rate threshold Q11 under high pressure even after the time predetermined t11 has elapsed since the operation is shifted to the first period or the high-pressure mode. In such case, it is determined that it is difficult to form an underground path for obtaining a desired air-flow rate even if the high-pressure mode is continued any longer. In such case, when the predetermined time t11 has elapsed, the control unit 150 sets and controls the exhaust pressure of the compressor pump 120 to the second pressure P21, which is the initial value of the low-pressure mode (the second period), and shifts the operation to the low-pressure mode. A value of the second pressure P21 to be used and other operations in such case will be explained later.

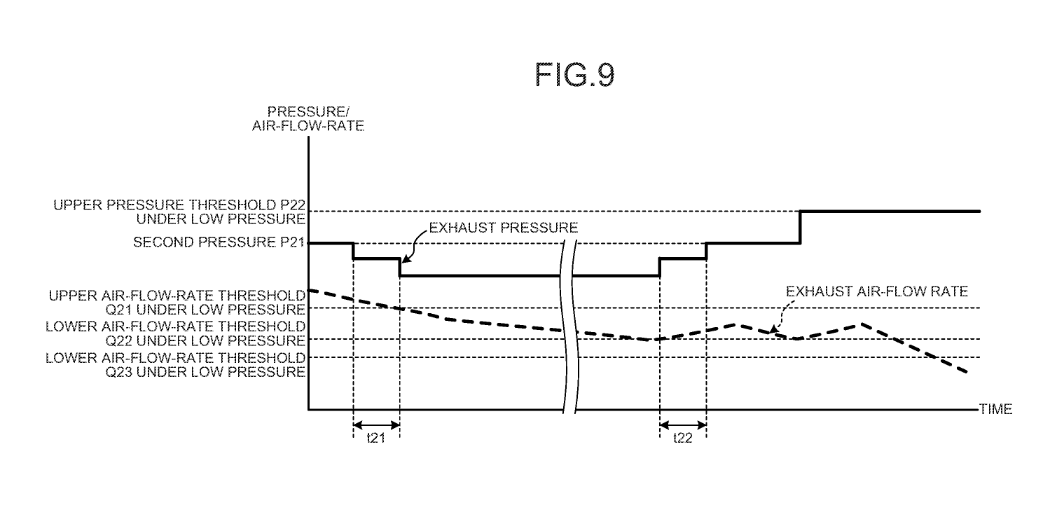

The exhaust pressure control by the control unit 150 is explained below in detail with reference to FIG. 9. FIG. 9 is a schematic diagram for explaining an example of the exhaust pressure control by the control unit 150 in the low-pressure mode.

According to the example depicted in FIG. 9, when, in the low-pressure mode, the exhaust air-flow rate of the exhaust pipe 161 is equal to or higher than the upper air-flow-rate threshold Q21 under low pressure, the control unit 150 decreases the exhaust pressure. It is assumed that when the exhaust pressure is equal to or higher than the upper air-flow-rate threshold Q21 under low pressure, air inside the computer room 110 sufficiently circulates via the soil 12. In other words, because air inside the computer room 110 can sufficiently circulate as long as the exhaust pressure is equal to or higher than the upper air-flow-rate threshold Q21 under low pressure, the control unit 150 decreases the exhaust pressure. In this way, the control unit 150 decreases the exhaust pressure, thereby being capable to prevent air from rising in the compressor pump 120, and to reduce power consumption.

When the exhaust air-flow rate of the exhaust pipe 161 then becomes equal to or lower than the lower air-flow-rate threshold Q22 under low pressure The control unit 150, as depicted in the example in FIG. 9, the control unit 150 increases the exhaust pressure of the compressor pump 120. The control unit 150 increases the exhaust pressure of the compressor pump 120 each time when the exhaust air-flow rate becomes equal to or lower than the lower air-flow-rate threshold Q22 under low pressure. While increasing the exhaust pressure, if the exhaust pressure of the exhaust pipe 161 reaches the upper pressure threshold P22 under low pressure, the control unit 150 stops increasing the exhaust pressure. When the exhaust air-flow rate of the exhaust pipe 161 then becomes equal to or lower than the lower air-flow-rate threshold Q23 under low pressure, the control unit 150 determines that the underground path is blocked, and shifts the operation to the high-pressure mode.

In this way, the control unit 150 regulates the exhaust pressure of the compressor pump 120 based on the exhaust air-flow rate of the exhaust pipe 161. The control unit 150 shifts the operation to the high-pressure mode when the exhaust air-flow rate of the exhaust pipe 161 becomes equal to or lower than the predetermined lower air-flow-rate threshold Q23 even if the exhaust pressure of the compressor pump 120 is set to the upper pressure threshold P22 under low pressure.

Exhaust Pressure Control by Control Unit 150 in High-Pressure Mode

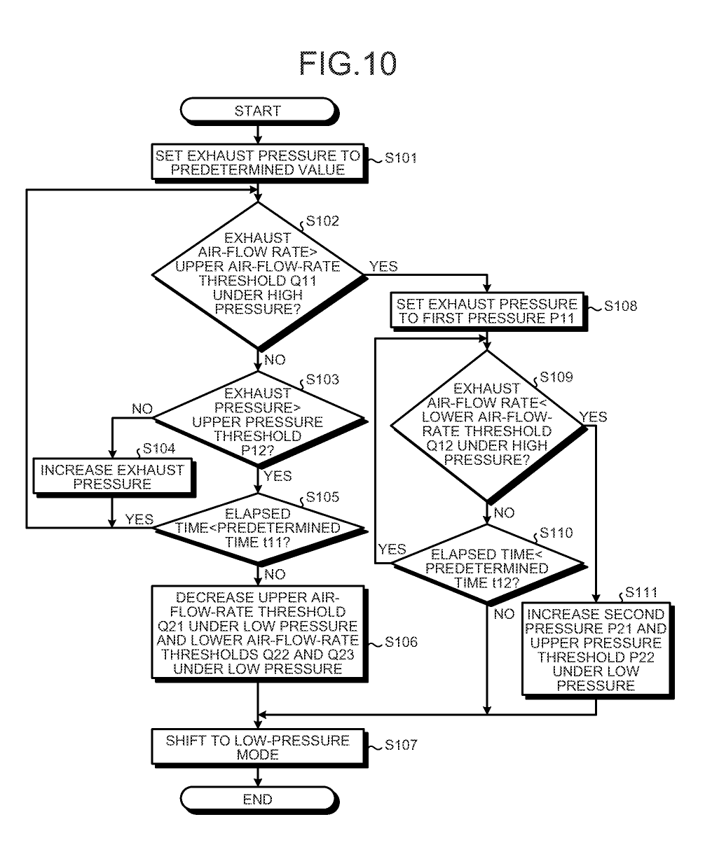

The exhaust pressure control by the control unit 150 in the high-pressure mode is explained below with reference to FIG. 10. FIG. 10 is a flowchart that depicts the exhaust pressure control by the control unit 150 in the high-pressure mode. The exhaust pressure control by the control unit 150 is explained below by using the examples depicted in FIGS. 5 to 8.

As depicted in FIG. 10, in the high-pressure mode, to begin with, the control unit 150 sets and controls the exhaust pressure of the compressor pump 120 to a predetermined value (Step S101). The “predetermined value” is, for example, the first pressure.

Subsequently, the control unit 150 acquires the exhaust air-flow rate of the exhaust pipe 161 from the air-flow rate sensor 172, and determines whether the acquired exhaust air-flow rate is higher than the upper air-flow-rate threshold Q11 under high pressure (Step S102). If the exhaust air-flow rate is equal to or lower than the upper air-flow-rate threshold Q11 under high pressure (No at Step S102), the control unit 150 acquires the exhaust pressure from the pressure sensor 171, and determines whether the acquired exhaust pressure is higher than the upper pressure threshold P12 (Step S103).

If the exhaust pressure of the exhaust pipe 161 is equal to or lower than the upper pressure threshold P12 (No at Step S103), the control unit 150 increases the exhaust pressure of the compressor pump 120 (Step S104), and then goes back to the processing at Step S102. By contrast, if the exhaust pressure of the exhaust pipe 161 is higher than the upper pressure threshold P12 (Yes at Step S103), the control unit 150 determines whether the predetermined time t11 has elapsed since the operation is shifted to the high-pressure mode (Step S105).

If the predetermined time t11 has not elapsed (Yes at Step S105), the control unit 150 then goes back to the processing at Step S102, and keeps the upper pressure threshold P12. By contrast, if the predetermined time t11 has elapsed despite that the exhaust air-flow rate is equal to or lower than the upper air-flow-rate threshold Q11 (No at Step S105), the control unit 150 decreases values of the upper air-flow-rate threshold Q21 under low pressure, and the lower air-flow-rate thresholds Q22 and Q23 under low pressure (Step S106), and then shifts the operation to the low-pressure mode (Step S107).

A case where the predetermined time t11 has elapsed before the exhaust air-flow rate becomes higher than the upper air-flow-rate threshold Q11 under high pressure corresponds to the example depicted in FIG. 8. In the example depicted in FIG. 8, even though air is discharged into the soil 12, there is a possibility that underground path sufficient to obtain a desired air-flow rate may not be formed. However, because air is discharged into the soil 12 at a high pressure, it is conceivable that an underground path through which a small quantity of air moves is formed. Therefore, when the predetermined time t11 has elapsed, the control unit 150 shifts the operation to the low-pressure mode in order to circulate air by using the formed underground path. At that moment, because there is a possibility that little quantity of air circulates in the formed underground path, the control unit 150 decreases the values of the upper air-flow-rate threshold Q21 under low pressure, and the lower air-flow-rate thresholds Q22 and Q23 under low pressure. Accordingly, even when the exhaust air-flow rate of the exhaust pipe 161 is small, timing of shifting the operation from the low-pressure mode to the high-pressure mode for re-forming an underground path can be delayed, so that the control unit 150 can perform the air-conditioning control by using ground temperature as much as possibly.

A case where the exhaust pressure reaches the upper pressure threshold P12 before the exhaust air-flow rate becomes higher than the upper air-flow-rate threshold Q11 under high pressure corresponds to the example depicted in FIG. 6 or 7. In the example depicted in FIG. 6 or 7, because there is a possibility that only a fixed underground path is formed in the soil 12 if the exhaust pressure of the exhaust pipe 161 is increased to higher than the upper pressure threshold P12, the control unit 150 fixes the exhaust pressure of the compressor pump 120 at the upper pressure threshold P12.

Returning to the explanation of FIG. 10, when the exhaust air-flow rate becomes higher than the upper air-flow-rate threshold Q11 under high pressure (Yes at Step S102), the control unit 150 sets and controls the exhaust pressure of the compressor pump 120 to the first pressure P11 (Step S108).

Subsequently, the control unit 150 determines whether the exhaust air-flow rate of the exhaust pipe 161 is lower than the lower air-flow-rate threshold Q12 under high pressure (Step S109). If the exhaust air-flow rate is equal to or higher than the lower air-flow-rate threshold Q12 under high pressure (No at Step 109), the control unit 150 determines whether the predetermined time t12 has elapsed since the exhaust pressure is set to the first pressure P11 (Step S110). When the predetermined time t12 has elapsed (No at Step S110), the control unit 150 shifts the operation to the low-pressure mode (Step S107).

A case where the predetermined time t12 has elapsed since the exhaust pressure is set and controls to the first pressure P11 corresponds to the examples depicted in FIGS. 5 and 6. In the examples depicted in FIGS. 5 and 6, the control unit 150 determines that an underground path sufficient to obtain a desired air-flow rate is formed, and then shifts the operation to the low-pressure mode.

By contrast, if the exhaust air-flow rate becomes lower than the lower air-flow-rate threshold Q12 under high pressure before a lapse of the predetermined time t12 (Yes at Step S109), the control unit 150 sets values of the second pressure P21 and the upper pressure threshold P22 under low pressure by increasing them to higher values than the standard default values (Step S111). The control unit 150 then shifts the operation to the low-pressure mode (Step S107).

A case where the exhaust air-flow rate becomes lower than the lower air-flow-rate threshold Q12 under high pressure before the predetermined time t12 has elapsed since the exhaust pressure is set to the first pressure P11 corresponds to the example depicted in FIG. 7. In the example depicted in FIG. 7, because the exhaust air-flow rate when discharging air into the soil 12 at the first pressure P11 is small, it is considered that the resistance in the underground path is large, and the second pressure P21 in the low-pressure mode is set to the standard default value, so that the exhaust air-flow rate becomes lower than those in the examples in FIGS. 5 and 6. For this reason, in order to circulate air at a desired air-flow rate through the formed underground path, it is desirable to increase the second pressure P21, compared with the examples depicted in FIGS. 4 and 5. Therefore, when the exhaust air-flow rate becomes lower than the lower air-flow-rate threshold Q12 under high pressure before a lapse of the predetermined time t12, in order to circulate air at a desired air-flow rate by sing the formed underground path, the control unit 150 shifts the operation to the low-pressure mode by increasing the values of the second pressure P21 and the upper pressure threshold P22 under low pressure. Accordingly, the control unit 150 can perform the air-conditioning control by using ground temperature.

Exhaust Pressure Control by Control Unit 150 in Low-Pressure Mode

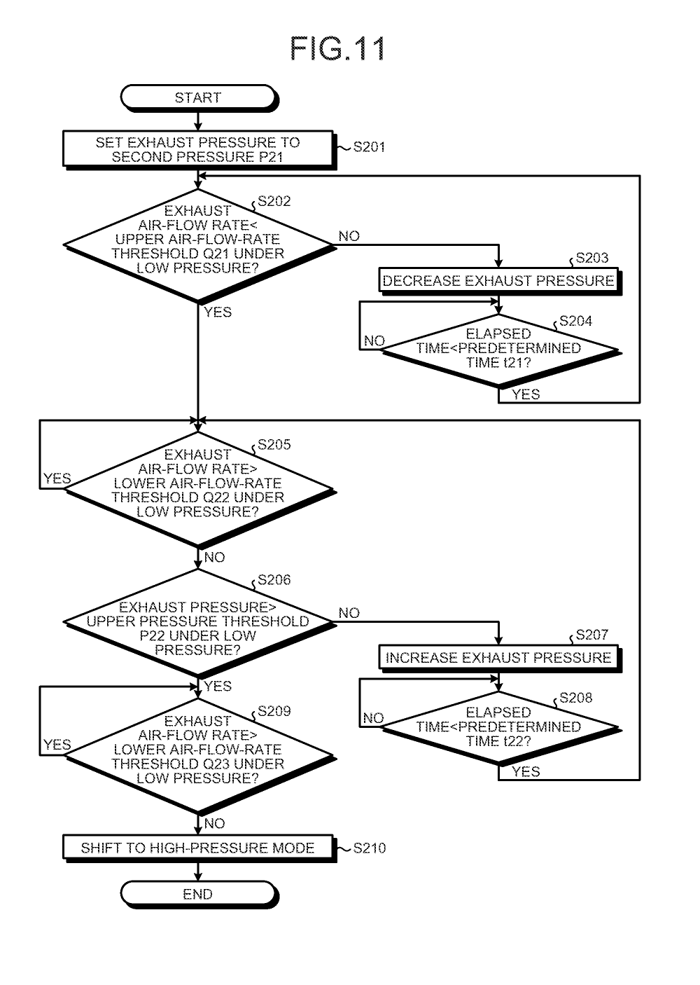

The exhaust pressure control by the control unit 150 in the low-pressure mode is explained below with reference to FIG. 11. FIG. 11 is a flowchart that depicts the exhaust pressure control by the control unit 150 in the low-pressure mode.

As depicted in FIG. 11, when the operation is shifted to the low-pressure mode, the control unit 150 sets and controls the exhaust pressure of the compressor pump 120 to the second pressure P21 (Step S201). Subsequently, the control unit 150 acquires the exhaust air-flow rate from the air-flow rate sensor 172, and determines whether the acquired exhaust air-flow rate is lower than the upper air-flow-rate threshold Q21 under low pressure (Step S202). If the exhaust air-flow rate is equal to or higher than the upper air-flow-rate threshold Q21 under low pressure (No at Step S202), the control unit 150 decreases the exhaust pressure (Step S203). After a lapse of a predetermined time t21 (Yes at Step S204), the control unit 150 then goes back to the processing at Step S202.

By contrast, if the exhaust air-flow rate is lower than the upper air-flow-rate threshold Q21 under low pressure (Yes at Step S202); the control unit 150 determines whether the exhaust air-flow rate is higher than the lower air-flow-rate threshold Q22 under low pressure (Step S205). When the exhaust air-flow rate then becomes equal to or lower than the lower air-flow-rate threshold Q22 under low pressure (No at Step S205), the control unit 150 acquires the exhaust pressure from the pressure sensor 171, and determines whether the acquired exhaust pressure is higher than the upper pressure threshold P22 under low pressure (Step S206).

If the exhaust pressure is equal to or lower than the upper pressure threshold P22 under low pressure (No at Step S206), the control unit 150 increases the exhaust pressure (Step S207). After a lapse of a predetermined time t22 (Yes at Step S208), the control unit 150 then goes back to the processing at Step S205. By contrast, if the exhaust pressure is higher than the upper pressure threshold P22 under low pressure (Yes at Step S206); the control unit 150 determines whether the exhaust air-flow rate is higher than the lower air-flow-rate threshold Q23 under low pressure (Step S209).

When the exhaust air-flow rate becomes equal to or lower than the predetermined lower air-flow-rate threshold Q23 under low pressure (No at Step S209), the control unit 150 shifts the operation to the high-pressure mode (Step S210). In other words, the control unit 150 performs the processing depicted in FIG. 10. According to a series of control in the low-pressure mode described above, air that is cooled at ground temperature via an underground path can be circulated indoors; a temperature rise caused by an exhaust pressure can be prevented; and ground temperature can be effectively used for cooling with small power consumption.

Example of Exhaust Pressure and Others

Concrete values of the first pressure and the second pressure described above are explained below. As described above, the control unit 150 sets and controls the exhaust pressure of the compressor pump 120 to the first pressure, in the high-pressure mode of the first period. This is for forming a desired underground path by discharging air into the soil 12 at the first pressure. To discuss a concrete value of the first pressure, the following description is explained by using and example of soil improvement.

For example, when soil includes a liquid, such as water, there is a possibility that the soil may be liquefied due to an earthquake, consequently the ground foundation may collapse. For this reason, generally, as the soil is improved, a liquid contained in the soil is sometimes replaced with air in some cases. Specifically, when improving soil, air and sand are discharged at a certain pressure. When discharging them, it is known that as air is discharged into the soil at a pressure equal to or higher than a certain value, a path is formed in the soil. Although it is not desirable in the field of soil improvement that a path is formed in soil, according to the air-conditioning control system disclosed in the present application, a path is positively formed in soil by using such characteristics of soil.

It is known that generally when the exhaust pressure of the exhaust pipe 161 is set to equal to or higher than approximately 70 kilopascals, air can be discharged in to soil (for example, see <reference documents>described below). Therefore, the first pressure described above is desirable to be set to, for example, equal to or higher than 70 kilopascals. Moreover, because it is known that when air is discharged into soil at a pressure equal to or higher than 300 kilopascals, a fixed underground path is formed in the soil 12; the upper pressure threshold P12 described above is desirably set to, for example, approximately 300 kilopascals.

### REFERENCE DOCUMENTS

(1) [http://www.cuee.titech.ac.jp/syutoken/activities/h19pdf/11.pdf] “Basic study for development of cheap countermeasure construction method against liquefaction by desaturation of ground foundation” (see 2.2 and others)
(2) [http://www.cuee.titech.ac.jp/syutoken/activities/h19pdf/12.pdf] “Experimental study about pile-sheet pile combined foundation aimed at improving quake resistance of pile foundation structure” (see 2.1 and others)
(3) [http://www.tech.nedo.go.jp/PDF/100001402.pdf] “Cooperation project of seawater desalination study for petroleum refining in oil-producing country” (see 4.3 and others)
(4) [http://www.tech.nedo.go.jp/PDF/100003019.pdf] “Cooperation project of seawater desalination study for oil-producing country (Oman)” (see 3.2.2 and others)

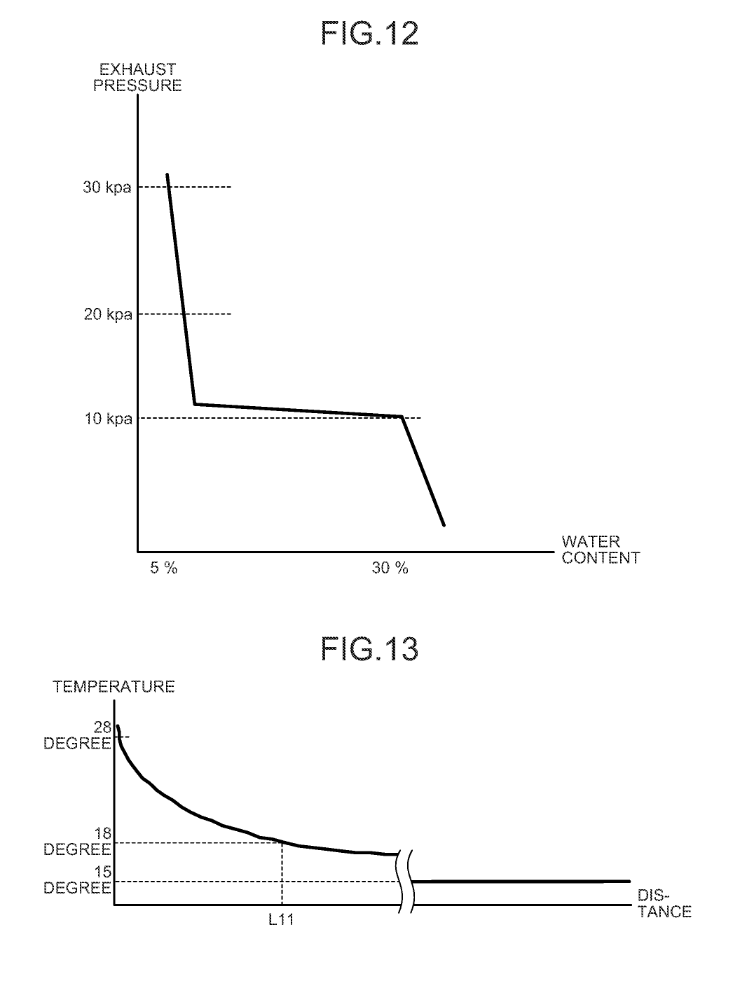

A concrete value of the second pressure is explained below. FIG. 12 is a schematic diagram for explaining a concrete example of a second pressure. The vertical axis depicted in FIG. 12 denotes the exhaust pressure of the exhaust pipe 161, and the horizontal axis denotes the water content of the soil 12. As depicted in an experiment data example in FIG. 12, exhaust pressures for circulating air in an underground path vary depending on the water content of the soil 12. For example, in a case of the example depicted in FIG. 12, when the water content of the soil 12 is 5%, it is desirable to set the second pressure to, for example, 30 kilopascals. When the water content of the soil 12 is between 6% and 30%, it is desirable to set the second pressure to, for example, between 10 kilopascals and 20 kilopascals. The water content in the soil 12 is indicated in FIG. 12, and it is desirable to set the second pressure to a similar value, even though part of water is replaced with air in a non-water resistant layer under the ground.

A distance between the exhaust pipe 161 and the suction pipe 162 is explained below. FIG. 13 is a schematic diagram that depicts relation between the distance between pipes and the temperature. The vertical axis depicted in FIG. 13 denotes temperature, and the horizontal axis denotes the distance between the exhaust pipe 161 and the suction pipe 162. It is assumed that the temperature depicted in FIG. 13 is the temperature of air sucked by the suction pipe 162. The temperature is detected by, for example, the temperature sensor 173b.

As depicted in an example in FIG. 13, the longer the distance between the exhaust pipe 161 and the suction pipe 162, the temperature of the air sucked by the suction pipe 162 is the lower. The reason for this is because the longer the distance between the exhaust pipe 161 and the suction pipe 162, a time in which air is cooled at ground temperature is the longer. Because it is assumed in FIG. 13 that the ground temperature is at 15° C., FIG. 13 depicts an example where the temperature of air sucked by the suction pipe 162 does not become equal to or lower than 15° C. It is desirable to determine embedding positions of the exhaust pipe 161 and the suction pipe 162 by using data as depicted in FIG. 13. For example, in the example depicted in FIG. 13, when the temperature of an exhaust temperature from the exhaust pipe 161 is 28° C., and the temperature of air sucked by the suction pipe 162 is set to 18° C.; it is desirable to determine respective embedding positions of the exhaust pipe 161 and the suction pipe 162 such that a distance between the both pipes is to become L11.

Effects of Second Embodiment

As described above, when the exhaust air-flow rate is equal to or lower than the predetermined lower air-flow-rate threshold Q23, the air-conditioning control system 100 according to the second embodiment discharges air from the exhaust pipe 161 into the soil 12 at the first pressure that is a high pressure. Accordingly, the air-conditioning control system 100 can form an underground path in the soil 12.

Moreover, after the underground path is formed, the air-conditioning control system 100 discharges air from the exhaust pipe 161 into the soil 12 at the second pressure that is a low pressure, thereby circulating indoor air in the underground path, cooling it at ground temperature, and delivering the cooled air indoors. Accordingly, the air-conditioning control system 100 according to the second embodiment can cool the air diffused in the soil 12 at ground temperature, thereby being capable to cool the indoor air at ground temperature efficiently.

According to the example depicted in FIG. 2, the air cooled at ground temperature is mixed with indoor air of which temperature rises with heat generated from electronics equipment, by the air mixing unit 116 on a side of air flowing into the chiller 140, and circulated indoors via the chiller. According to the example, the chiller 140 sucks the air cooled at ground temperature by mixing, so that the chiller 140 performs cooling processing on air at a lower temperature than the air in the computer room 110. Accordingly, the air-conditioning control system 100 depicted in FIG. 2 can reduce an operation load on the chiller 140 and also can perform a cooling operation in an efficient range at a low temperature, thereby being capable to reduce power consumption by the chiller 140.

Although according to the example in FIG. 2, air is circulated by inputting the air cooled at ground temperature into the air mixing unit 116, the embodiments in the present application are not limited to the example in FIG. 2. For example, an effect can be obtained by returning and circulating air cooled at ground temperature directly into the underfloor air duct 113. In such case, the input temperature to the chiller is to be a temperature similar to that in a case without using ground temperature; however, air cooled at ground temperature is supplied to the underfloor air duct 113, so that an air-flow rate of the chiller can be reduced, and/or an output temperature of the chiller can be slightly raised, consequently power consumption by the chiller 140 can be similarly reduced. Moreover, an effect can be also obtained by forming the air duct 115 on the output side of the blower 130 in FIG. 2 so as to be guided directly to the electronics equipment 111, and circulating air cooled at ground temperature. In such case, for example, a partial temperature rise can be prevented by intensively supplying the air cooled at ground temperature to electronics equipment that has a particularly large heat release, so that the exhaust air-flow rate of the chiller 140 can be reduced, and an output temperature can be raised, resulting in reduction in power consumption by the chiller 140.

### [c] Third Embodiment

The first and the second embodiments describe above the examples that one unit of the exhaust pipe 161 and one unit of the suction pipe 162 are embedded in the soil 12. However, the air-conditioning control system disclosed in the present application can be configured to include a plurality of the exhaust pipes 161 and a plurality of the suction pipes 162. A third embodiment according to the present invention is explained below about an example of an air-conditioning control system that includes a plurality of the exhaust pipes 161 and a plurality of the suction pipes 162.

An air-conditioning control system 200 according to the third embodiment includes a plurality of exhaust pipes and a plurality of suction pipes. A configuration of the air-conditioning control system 200 according to the third embodiment is similar to the configuration of the air-conditioning control system 100 depicted in FIG. 2 except that the number of exhaust pipes and the number of suction pipes. Hereinafter, to distinguish between the control unit 150 according to the second embodiment and a control unit according to the third embodiment, the control unit according to the third embodiment is referred to as a “control unit 250”.

Example of Embedding Position

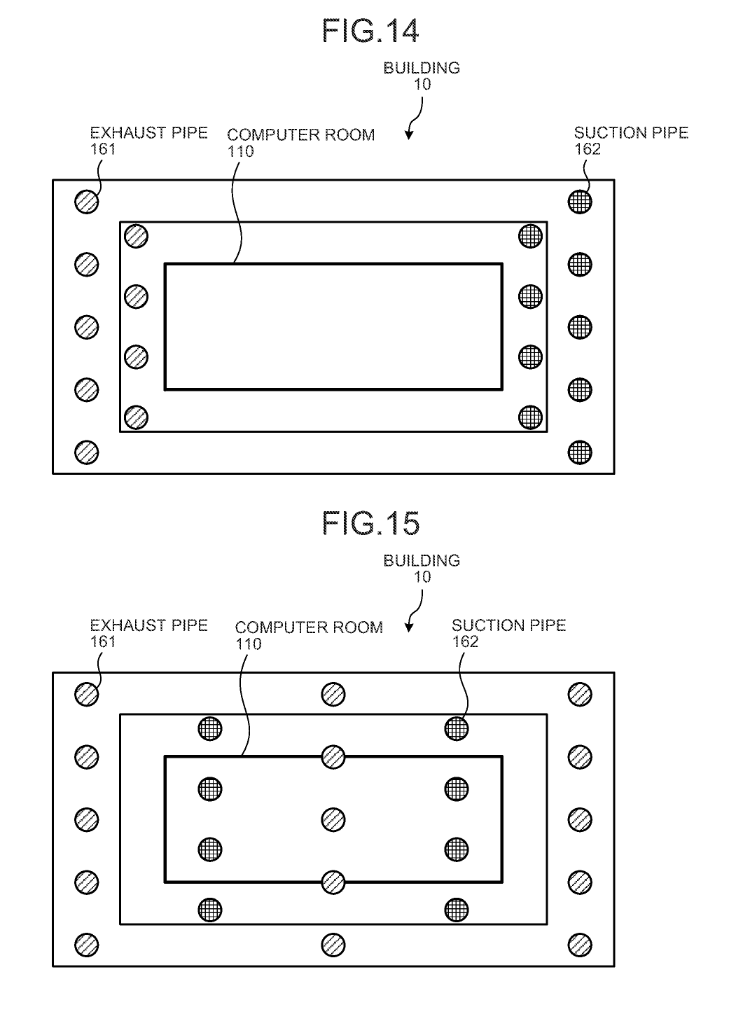

First of all, embedding positions of the exhaust pipes 161 and the suction pipes 162 in the air-conditioning control system 200 according to the third embodiment are explained below with reference to FIGS. 14 to 16. FIGS. 14 to 16 are schematic diagrams that depict examples of embedding positions of the exhaust pipes 161 and the suction pipes 162. FIGS. 14 to 16 are schematic diagrams of a top view from the ceiling of the computer room 110 depicted in FIG. 2.

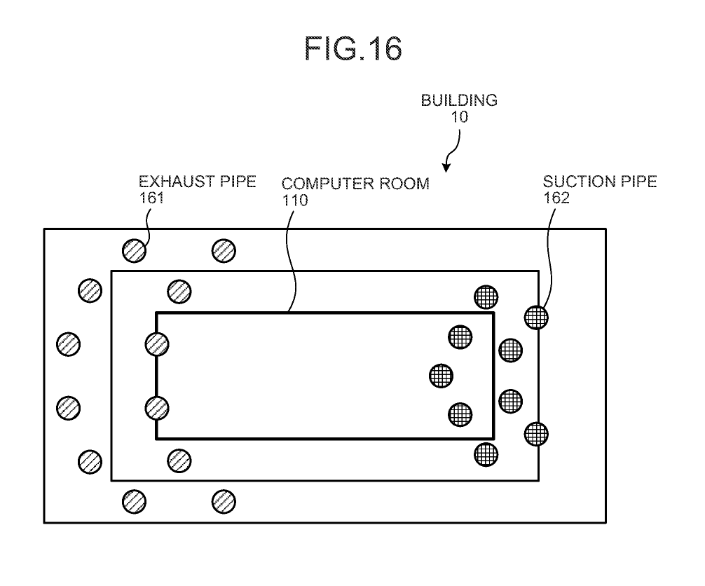

According to an example depicted in FIG. 4, the number of the exhaust pipes 161 and the number of the suction pipes 162 are the same, and the exhaust pipes 161 and the suction pipes 162 are embedded in parallel. According to an example depicted in FIG. 15, the number of the exhaust pipes 161 is more than that of the suction pipes 162, and the exhaust pipes 161 and the suction pipes 162 are embedded in a staggered arrangement. According to an example depicted in FIG. 16, the number of the exhaust pipes 161 is more than that of the suction pipes 162, and the exhaust pipes 161 and the suction pipes 162 are embedded concentrically.

Configuration of Compressor Pump 120

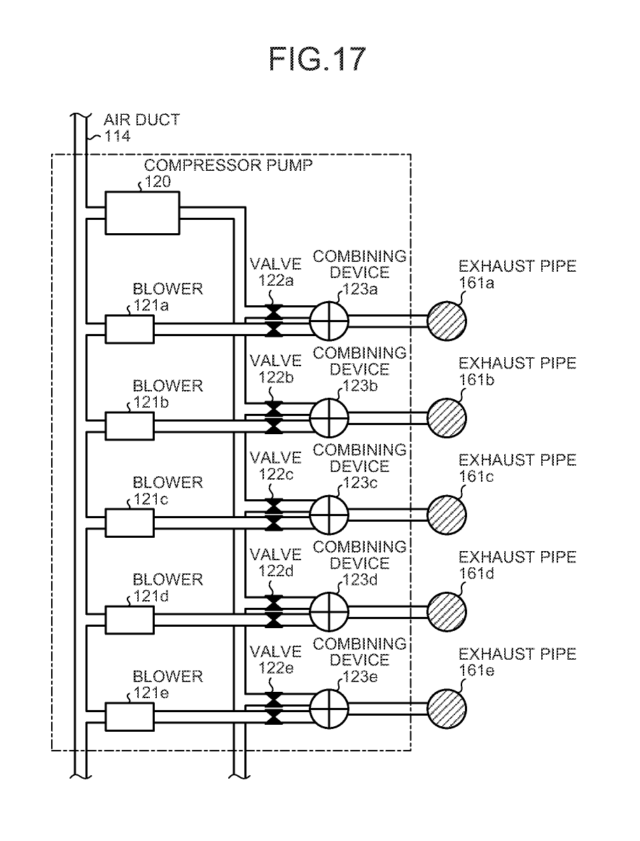

Even in the cases where the plurality of the exhaust pipes 161 is embedded in the soil 12 as described above, the air-conditioning control system 200 does not need to include a plurality of units of the compressor pump 120 and the blower 130. A configuration example of the compressor pump 120 is depicted in FIG. 17. The compressor pump 120 depicted in FIG. 17 is particularly useful when a plurality of the exhaust pipes 161 is embedded in the soil 12.

As depicted in FIG. 17, the compressor pump 120 includes blowers 121a to 121e, valves 122a to 122e, and combining devices 123a to 123e. The blowers 121a to 121e suck air in the air duct 114 at a certain pressure, and deliver into the valves 122a to 122e, respectively.

The valves 122a to 122e open and close respective spaces through which air circulates between the blowers 121a to 121e and the combining devices 123a to 123e. Moreover, the valves 122a to 122e open and close respective spaces through which air circulates between the compressor pump 120 and the combining devices 123a to 123e. The combining devices 123a to 123e combine air delivered from the compressor pump 120 and air delivered from the blowers 121a to 121e, and then deliver the combined air outward to the exhaust pipes 161a to 161e, which are connected to the combining devices 123a to 123e, respectively.

It is assumed that five of the exhaust pipes 161a to 161e are embedded in the soil 12. Moreover, it is assumed that the exhaust pipes 161a to 161e are connected to the compressor pump 120 as depicted in the example in FIG. 17. In such case, the control unit 250 can simultaneously delivers air in the computer room 110 outward to the exhaust pipes 161a to 161e by opening the valves 122a to 122e. However, when simultaneously delivering air outward to the exhaust pipes 161a to 161e in the high-pressure mode, it is needed to set the pressure of the compressor pump 120 high in order to form an underground path. In such case, there is a possibility that air may turn to a high temperature caused by the compressor pump 120, and/or power consumption may increase.

Therefore, when forming an underground path, the control unit 250 can deliver air outward to the exhaust pipes 161a to 161e one by one. For example, the control unit 250 opens the valve 122a, and closes the valves 122b to 122e. At that moment, the control unit 250 can stop the blowers 121b to 121e. Accordingly, air in the computer room 110 is delivered outward only to the exhaust pipe 161a at a high pressure. The control unit 250 then performs the processing depicted in FIG. 10, thereby forming an underground path between the exhaust pipe 161a and a certain suction pipe. Subsequently, the control unit 250 closes the valve 122a, and opens the valve 122b. Accordingly, air in the computer room 110 is delivered outward only to the exhaust pipe 161b at a high pressure. The control unit 250 then performs the processing depicted in FIG. 10, thereby forming an underground path between the exhaust pipe 161b and a certain suction pipe. The control unit 250 performs similar processing on the exhaust pipes 161c to 161e.

In this way, when using a plurality of exhaust pipes, the air-conditioning control system 200 can deliver air outward to a plurality of exhaust pipes one by one at a high pressure. Accordingly, the air-conditioning control system 200 does not need constantly to set the exhaust pressure of the compressor pump 120 to a high value when forming an underground path. As a result, even when using a plurality of exhaust pipes, the air-conditioning control system 200 can prevent air from becoming a high temperature caused by the compressor pump 120, and can suppress increase in power consumption.

Effects of Third Embodiment

As described above, the air-conditioning control system 200 according to the third embodiment uses a plurality of exhaust pipes and a plurality of suction pipes, thereby circulating air between the inside of a room and an underground path in the soil 12. Accordingly, the air-conditioning control system 200 can cool a large volume of indoor air at ground temperature, so that indoor air can be efficiently cooled.

### [d] Fourth Embodiment

The first to the third embodiments describe above the examples that indoor air is cooled by using ground temperature. The air-conditioning control system disclosed in the present application can vary operation loads on a chiller based on a cooling efficiency at ground temperature. A fourth embodiment according to the present invention is explained below in a case where operation loads on the chiller are varied based on a cooling efficiency at ground temperature.

It is assumed that an air-conditioning control system 300 according to the fourth embodiment includes a plurality of exhaust pipes and a plurality of suction pipes. A configuration of the air-conditioning control system 300 according to the fourth embodiment is similar to the configuration of the air-conditioning control system 100 depicted in FIG. 2 except that the number of exhaust pipes and the number of suction pipes. Moreover, it is assumed that a configuration of the compressor pump 120 according to the fourth embodiment is similar to the configuration of the compressor pump 120 depicted in FIG. 17. Hereinafter, to distinguish between the control unit 150 according to the second embodiment and a control unit according to the fourth embodiment, the control unit according to the fourth embodiment is referred to as a “control unit 350”.

Control by Control Unit 350 According to Fourth Embodiment

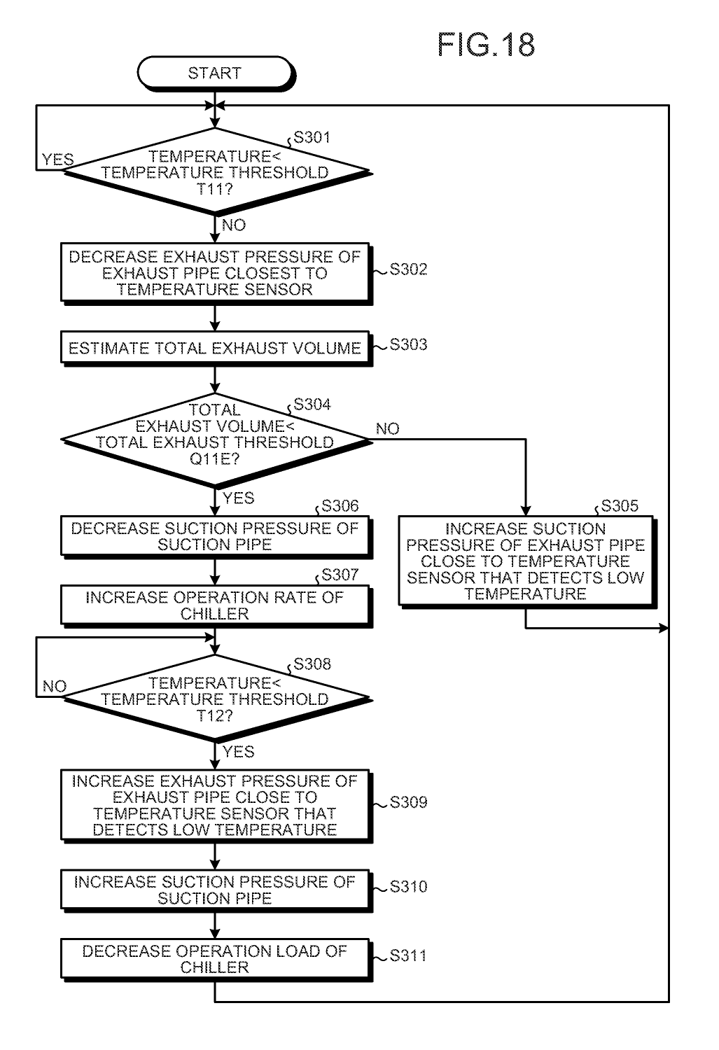

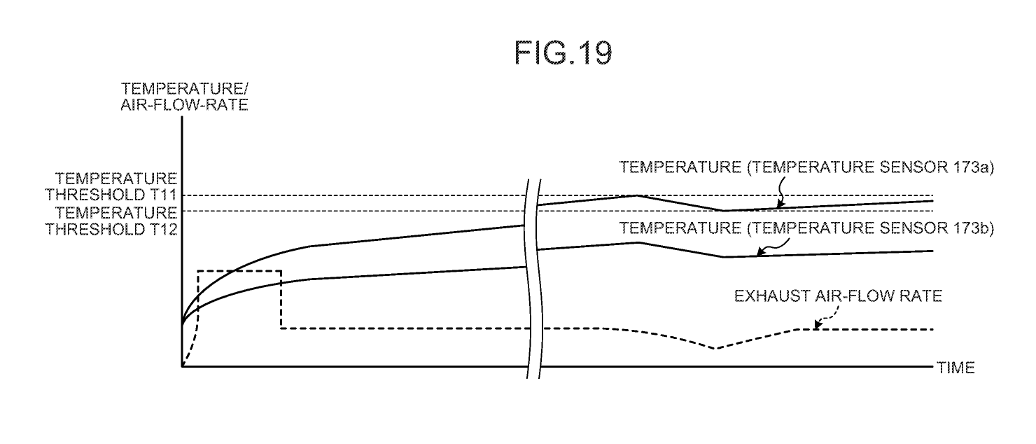

Air-conditioning control by the air-conditioning control system 300 according to the fourth embodiment is explained below with reference to FIGS. 18 and 19. FIG. 18 is a flowchart that depicts control by the control unit 350 according to the fourth embodiment. FIG. 19 is a schematic diagram for explaining the control by the control unit 350 according to the fourth embodiment. The vertical axis depicted in FIG. 19 denotes temperature or air-flow rate, and the horizontal axis denotes time. Solid lines in FIG. 19 indicate temperatures of air sucked by suction pipes, and a broken line indicates the exhaust air-flow rate. FIG. 19 depicts a temperature detected by the temperature sensor 173a depicted in FIG. 2, and a temperature detected by the temperature sensor 173b. An example of performing air-conditioning control based on a temperature detected by the temperature sensor 173a is explained below.

As depicted in FIG. 18, the control unit 350 according to the fourth embodiment acquires a temperature detected by the temperature sensor 173a, and determines whether the acquired temperature is lower than a predetermined temperature threshold T11 (Step S301). It is assumed that when the temperature of air sucked by a suction pipe is equal to or higher than the temperature threshold T11, the air sucked by the suction pipe can not contribute cooling for the computer room 110. For example, suppose the temperature of air sucked by a suction pipe is “28° C.”, and the computer room 110 is intended to be cooled to equal to or lower than “22° C.”. In such case, even if the air of 28° C. is delivered into the computer room 110, the computer room 110 is not cooled.

Therefore, when the temperature is equal to or higher than the temperature threshold T11 (No at Step S301), the control unit 350 decreases the exhaust pressure of an exhaust pipe that is embedded at the closest position to the temperature sensor 173a (Step S302). In this way, by decreasing the exhaust pressure of the exhaust pipe that is embedded at the closest position to the temperature sensor 173a, the control unit 350 decreases the air-flow rate of air discharged from the exhaust pipe, as depicted in the example in FIG. 19. Accordingly, hot air discharged into the underground path is decreased, so that the control unit 350 can improve the cooling efficiency of air at ground temperature.

Subsequently, the control unit 350 estimates a total of air-flow rates discharged from the exhaust pipes embedded in the soil 12 (hereinafter, “total exhaust volume”) (Step S303). Specifically, the control unit 350 estimates a total exhaust volume based on operation states of the blowers included in the compressor pump 120, and open-close states of the valves 122.

Subsequently, the control unit 350 determines whether the total exhaust volume estimated at Step S303 is less than a predetermined total exhaust threshold Q11E (Step S304). If the total exhaust volume estimated is equal to or more than the predetermined total exhaust threshold Q11E (No at Step S304), the control unit 350 determines that a cooling capacity for air by using ground temperature is sufficient for a cooling capacity that is expected in advance. To increase air to be discharged from an exhaust pipe of which cooling capacity at ground temperature is high, the control unit 350 increases the exhaust pressure of an exhaust pipe embedded close to the temperature sensor that detects a low temperature (Step S305).

By contrast, if the total exhaust volume is less than a predetermined total exhaust threshold Q11E (Yes at Step S304), the control unit 350 determines that a cooling capacity for air by using ground temperature is smaller than the cooling capacity that is expected in advance because the total volume of air discharged into the soil 12 is small. The control unit 350 then reduces the air-flow rate by decreasing the suction pressure of the suction pipes such that the temperature of air sucked from the suction pipes does not rise excessively (Step S306), and increases the operation load on the chiller 140 (Step S307).

In this way, when the cooling efficiency by using ground temperature decreases, the control unit 350 reduces the total volume of air to be sucked from the soil 12, and increases the operation load on the chiller 140, thereby cooling the inside of the computer room 110.

Subsequently, the control unit 350 acquires a temperature detected by the temperature sensor 173a, and determines whether the acquired temperature is lower than a predetermined temperature threshold T12 (Step S308). Therefore, when the temperature is lower than the temperature threshold T12 (Yes at Step S308), the control unit 350 increases the exhaust pressure of an exhaust pipe that is embedded at the closest position to the temperature sensor that detects the low temperature (Step S309). Moreover, the control unit 350 increases the suction pressure of the suction pipes (Step S310), and decreases the operation load on the chiller 140 (Step S311).

In this way, when the temperature detected by the temperature sensor 173a becomes lower than the temperature threshold T12, the control unit 350 performs again the processing between Steps S309 to S311 described above in order to use the cooling function for air by using ground temperature.

Effects of Third Embodiment

As described above, the air-conditioning control system 300 according to the fourth embodiment varies air-flow rates of air to be discharged into the exhaust pipes based on the temperature of air cooled at ground temperature. Accordingly, when cooling of air at ground temperature contributes cooling for the computer room 110, the air-conditioning control system 300 can use the cooling of air at ground temperature as much as possibly. As a result, the air-conditioning control system 300 can cool the computer room 110 efficiently.

### [e] Fifth Embodiment

The air-conditioning control system disclosed in the present application can implemented in various different forms in addition to the above embodiments. A fifth embodiment of the present invention explains below other embodiments of the air-conditioning control system disclosed in the present application.

(1) Relation Between Exhaust Air-Flow Rate and Suction Air-Flow Rate

In the above embodiments, it is preferable that each of the control units 150, 250, and 350 controls the exhaust pressure of the compressor pump 120 and the suction pressure of the blower 130 such that the exhaust air-flow rate of air discharged by the exhaust pipe(s) is to be equal to the suction air-flow rate of air sucked by the suction pipe(s). For example, in the example depicted in FIG. 2, it is preferable that the control unit 150 controls the exhaust pressure of the compressor pump 120 and the suction pressure of the blower 130 such that the exhaust air-flow rate of the exhaust pipe 161 and the suction air-flow rate of the suction pipe 162 become substantially equal to each other. Moreover, for example, in the example depicted in FIG. 14, it is preferable that the control unit 250 controls a total of exhaust air-flow rates of the nine exhaust pipes 161 and a total of the nine suction pipes 162 such that they become substantially equal to each other. The reason for this is because if an exhaust air-flow rate is equal to a suction air-flow rate, it can be said that air in the computer room 110 is not discarded into the ground, and is circulated via an underground path. In other words, by controlling the exhaust pressure and the suction pressure such that the exhaust air-flow rate of the exhaust pipe(s) and the suction air-flow rate of the suction pipe(s) become equal to each other, the control units 150, 250, and 350 can perform air-conditioning control that is more environmentally favorable than conventional technologies of only discharging air into ground and/or outdoors.

Furthermore, in the examples depicted in FIGS. 15 and 16, although the number of the exhaust pipes 161 is more than the number of the suction pipes 162, it is preferable for the control unit 150 to control such that a total of the exhaust air-flow rates of the exhaust pipes 161 becomes substantially equal to a total of the suction air-flow rates of the suction pipes 162. In such case, the exhaust pressure of the exhaust pipes, of which number is more than the suction pipes, can be set to lower, consequently environmentally favorable air-conditioning control can be performed, and an air-conditioning control system that prevents rise in temperature caused by the exhaust pressure and efficiently uses ground temperature can be achieved.

(2) Exhaust Pressure in First Period

The above embodiments describe the examples in which the exhaust pressure of the compressor pump 120 is set to the first pressure that is a high pressure. However, depending on properties of the soil 12, an underground path can be sometimes formed by discharging air even at a low pressure, in some cases. Therefore, in a case of the soil 12 in which an underground path can be formed even at a low pressure, the control units 150, 250, and 350 can set the exhaust pressure of the compressor pump 120 to a low pressure even in the first period. Accordingly, the air-conditioning control systems 100, 200, and 300 can form an underground path at a low pressure depending on properties of the soil 12, as a result, rise in temperature of air caused by the compressor pump 120 can be prevented, and power consumption can be reduced.

(3) Air-Conditioning Control Program

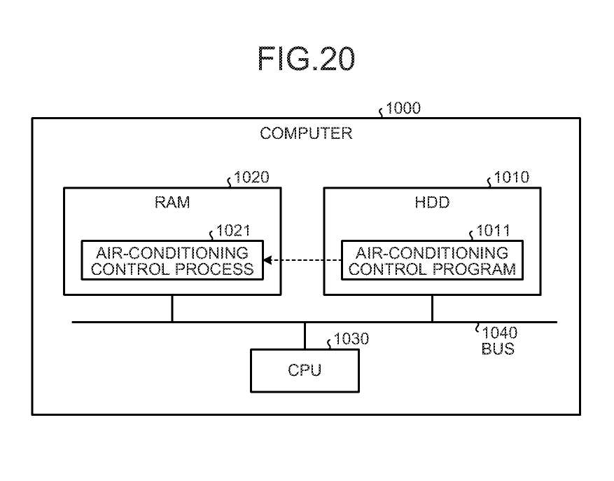

The various processing of the air-conditioning control systems explained in the first to the fourth embodiments can be implemented by executing a preliminarily prepared computer program by a computer system, such as a personal computer or a workstation. It can be executed by a microcomputer that is integrated in a control device. An example of a computer configured to execute an air-conditioning control program that has functions similar to those of the air-conditioning control system 100 explained above in the second embodiment is explained below with reference to FIG. 20. FIG. 20 is a schematic diagram that depicts a computer that executes an air-conditioning control program.

As depicted in FIG. 20, a computer 1000 as the air-conditioning control system 1 includes a hard disk drive (HDD) 1010, a random access memory (RAM) 1020, and a central processing unit (CPU) 1030, which are connected to each other with a bus 1040.

The HDD 1010 stores therein information to be used when executing various processing by the CPU 1030. The RAM 1020 stores therein various information temporarily. The CPU 1030 executes various computing processing.

Moreover, as depicted in FIG. 20, the HDD 1010 preliminarily there in an air-conditioning control program 1011 configured to perform functions similar to those performed by the control unit 150 of the air-conditioning control system 1 depicted in FIG. 2. The air-conditioning control program 1011 can be appropriately distributed, and stored by a storage unit of another computer that is connected to the computer 1000 via a network so as to be able to communicate.

The CPU 1030 then reads the air-conditioning control program 1011 from the HDD 1010, and develops it on the RAM 1020, so that the air-conditioning control program 1011 turns to functional as an air-conditioning control process 1021, as depicted in FIG. 20.

The air-conditioning control program 1011 is not necessarily to be initially stored in the HDD 1010. For example, each program can be stored in a “portable physical medium”, for example, a flexible disk (FD), a compact disk read only memory (CD-ROM), a digital versatile disk (DVD), an optical disk, an integrated circuit (IC) card, and the like. The computer 1000 can be configured to read the each program from those, and to execute it.

Furthermore, each program can be stored in “another computer (or a server)” that is connected to the computer 1000 via a public line, the Internet, a local area network (LAN), a wide area network (WAN), or the like. The computer 1000 can be configured to read the each program from those, and to execute it.

(4) System Configuration and Others

The components of each device depicted in the drawings are conceptual for describing functions, and not necessarily to be physically configured as depicted in the drawings. In other words, concrete forms of distribution and integration of the units are not limited to those depicted in the drawings, and all or part of the units can be configured to be functionally or physically distributed and integrated in an arbitrary unit depending on various loads and conditions in use.

Moreover, the number of the components and the numerical values depicted in the drawings are an example, and not necessarily to be configured as depicted in the drawings. For example, FIG. 2 depicts the example in which the air-conditioning control system 100 includes one unit of the chiller 140; however, the number of chillers included in the air-conditioning control system 100 is not limited to one. For example, the air-conditioning control system 100 can include two or more chillers.

According to an aspect of the air-conditioning control system disclosed in the present application, an effect is obtained such that the inside of a room can be efficiently cooled.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An air-conditioning control system comprising:
an exhaust pipe that discharges air into ground;
an outward delivery unit that delivers air in a room outward to the exhaust pipe at a predetermined exhaust pressure;
a suction pipe that sucks air discharged by the exhaust pipe via an underground path that is formed in ground by air discharged by the exhaust pipe; and
an inward delivery unit that delivers air sucked from the suction pipe at a predetermined suction pressure into the room.

2. The air-conditioning control system according to claim 1, further comprising a control unit that controls the exhaust pressure.

3. The air-conditioning control system according to claim 1, wherein the control unit sets the exhaust pressure to a first pressure when an exhaust air-flow rate of air discharged from the exhaust pipe into ground is equal to or lower than a predetermined lower air-flow rate threshold under low pressure, and sets the exhaust pressure to a second pressure that is lower than the first pressure when a predetermined time has elapsed since the exhaust pressure is set to the first pressure.

4. The air-conditioning control system according to claim 3, wherein
when the exhaust air-flow rate is equal to or lower than the lower air-flow-rate threshold under low pressure, the control unit increases the exhaust pressure until the exhaust air-flow rate becomes higher than a predetermined upper air-flow-rate threshold under high pressure, and
when the exhaust air-flow rate becomes higher than the upper air-flow-rate threshold under high pressure, the control unit sets the exhaust pressure to the first pressure.

5. The air-conditioning control system according to claim 4, wherein while increasing the exhaust pressure until the exhaust air-flow rate becomes higher than the upper air-flow-rate threshold under high pressure, when the exhaust pressure becomes higher than a predetermined upper pressure threshold, the control unit sets the exhaust pressure to a pressure equal to or lower than the upper pressure threshold, and sets the exhaust pressure to the first pressure after a lapse of a predetermined time.

6. The air-conditioning control system according to claim 3, wherein after the exhaust pressure is set to the first pressure, when the exhaust air-flow rate becomes lower than a lower air-flow-rate threshold under high pressure, the control unit sets the exhaust pressure to a pressure in a middle between the first pressure and the second pressure.

7. The air-conditioning control system according to claim 3, wherein the control unit determines that the first pressure is to be a pressure at which an underground path is formed in ground, in accordance with a property of soil that forms the ground.

8. The air-conditioning control system according to claim 3, further comprising a chiller that cools air in the room, wherein when a temperature of air sucked by the inward delivery unit from the suction pipe is higher than a predetermined temperature threshold, the control unit decreases the exhaust pressure and the suction pressure, and increases an operation load on the chiller.

9. The air-conditioning control system according to claim 2, wherein
the exhaust pipe includes at least one pipe, and the suction pipe includes at least one pipe, and
the control unit controls such that a total of air-flow rates of air discharged from the at least one pipe of the exhaust pipe become substantially equal to a total of air-flow rates of air sucked from the at least one pipe of the suction pipe.

10. The air-conditioning control system according to claim 1, wherein the number of pipes included in the exhaust pipe is more than the number of pipes included in the exhaust pipe.

11. The air-conditioning control system according to claim 2, wherein
the exhaust pipe includes plural pipes, and
the control unit controls an exhaust pressure of a pipe of the exhaust pipe positioned in a vicinity of a position at a high temperature in ground so as to be relatively lower than an exhaust pressure of a pipe of the exhaust pipe positioned in a vicinity of a position at a low temperature in ground.

12. An air-conditioning control method performed by an air-conditioning control system that includes an exhaust pipe that discharges air into ground and a suction pipe that sucks air from ground, the air-conditioning control method comprising:
delivering air in a room outward to the exhaust pipe with a predetermined exhaust pressure;
sucking air discharged by the exhaust pipe from a suction pipe with a predetermined suction pressure, via an underground path that is formed in ground at least partially by air discharged by the exhaust pipe;
delivering sucked air into the room;
setting the exhaust pressure to a first pressure when an exhaust air-flow rate of air discharged from the exhaust pipe into ground is equal to or lower than a predetermined lower air-flow rate threshold under low pressure; and
setting the exhaust pressure to a second pressure that is lower than the first pressure when a predetermined time has elapsed since the exhaust pressure is set to the first pressure.

13. A computer readable storage medium having stored therein an air-conditioning control program for controlling an air-conditioning control system that includes an exhaust pipe that discharges air into ground and a suction pipe that sucks air from ground, the air-conditioning control program causing a computer to execute a process comprising:
delivering air in a room outward to the exhaust pipe with a predetermined exhaust pressure;
sucking air discharged by the exhaust pipe from a suction pipe with a predetermined suction pressure, via an underground path that is formed in ground at least partially by air discharged by the exhaust pipe;
delivering sucked air into the room;
setting and controlling the exhaust pressure to a first pressure when an exhaust air-flow rate of air discharged from the exhaust pipe into ground is equal to or lower than a predetermined lower air-flow rate threshold under low pressure; and
setting and controlling the exhaust pressure to a second pressure that is lower than the first pressure when a predetermined time has elapsed since the exhaust pressure is set to the first pressure.
